(19) United States
(12) Patent Application Publication
(10) Pub. No.: US 2025/0264382 A1
(43) Pub. Date: Aug. 21, 2025

(54) System and Method to Control Particle Deposition on a Filter Membrane

(71) Applicant: SKC Inc., Eighty Four, PA (US)

(72) Inventor: Saulius Trakumas, Pittsburgh, PA (US)

(73) Assignee: SKC Inc., Eighty Four, PA (US)

(21) Appl. No.: 18/443,884

(22) Filed: Feb. 16, 2024

(51) Int. Cl. G01N 1/22

(52) U.S. Cl. CPC G01N 1/2205; G01N 2001/2288

(57) ABSTRACT

Embodiments relate to a sampler component. The sampler component includes a chamber configured to allow fluid to flow there-through, a filter configured to remove particles or contaminants from the fluid as it passes through the chamber and capture said particles or contaminants on the filter, and a apertured-member including at least one aperture. The apertured-member has zero-or low-fluid permeability to prevent the flow of fluid there-through. Fluid freely passes through the at least one aperture and particles or contaminants are deposited on the filter in the area of the at least one aperture.

### TECHNICAL FIELD

Embodiments can relate to a sampler and a method of sampling that facilitates control of particle deposition and minimizes particle losses by placing a thin disc with an aperture between a filter and a filter support of a sampler. Techniques described herein can facilitate use of the disc-filter arrangement in any existing sampler design—i.e., an existing sampler can be retrofitted with the disc-filter arrangement.

### BACKGROUND

To monitor the air quality and possible health effects of airborne contaminants, particle-laden air is drawn through a thin membrane filter that can be analyzed later to find particle mass concentration and chemical composition. A relatively simple weighing procedure is often used to find particle mass, while different analytical techniques are available to determine the chemical composition of collected particles. These latter techniques may be time-consuming and complicated, and in many situations may require acid digestion of the filter.

Methods are available that allow direct-on-filter elemental analysis, such as X-ray fluorescence (XRF), instrumental neutron activation analysis (INAA), Fourier-transform infrared spectroscopy (FTIR), and others. In some instances, even the mass of collected particulate matter can be found via measuring light absorption by material collected on the filter. A significant benefit of direct-on-filter methods is that they can provide much quicker results. In most situations, only part of the filter is being analyzed.

Therefore, it can be important to have the most uniform deposits possible and preferably have particles deposited in the smallest area possible. In addition, it can be important to ensure that all particles entering the sampler are deposited on a filter with minimal particle losses on the internal walls of the sampler.

Conventional samplers and sample methods can be appreciated from:
1. Baron, P. A., “Factors Affecting Aerosol Sampling,” NIOSH Manual of Analytical Methods (NMAM), 5th Edition, 2016.
2. Lee, T., Lee, L., Cauda, E., Hummer, J., & Harper, M. “Respirable Size-Selective Sampler for End-of-Shift Quartz Measurement: Development and Performance,” Journal of Occupational and Environmental Hygiene, 14(5), 2017, pp. 335-342.
3. Baron, P. A., “Personal Aerosol Sampler Design: A Review,” Applied Occupational and Environmental Hygiene, 13(5), 1998, pp. 313-320.
4. Blackford, D. B., Harris, G. W., & Revell, G., “The reduction of dust losses within the cassette of the SIMPEDS personal dust sampler,” Annals of Occupational Hygiene, 29, 1985, pp. 169-180.

Samplers have been designed to achieve the above-mentioned desired area of particle deposition by restricting particle-laden air upstream of the filter. Other samplers have been designed with a larger flange downstream of the filter. Some samplers include a special filter holder to decrease particle losses on their inner walls. Yet, conventional samplers and sampling methods tend to be complex, costly, and inefficient.

### SUMMARY OF THE INVENTION

Embodiments can relate to a sampler and a method of sampling that allows for control of particle deposition. The apparatus and method can also minimize particle losses by placing a thin disc with an aperture between a filter and a filter support of the sampler device. Embodiments of the technique disclosed herein can facilitate use of the apertured-disc in any existing sampler. This disc can be made of material with low or zero air permeability. The aperture can be round or any other shape. A number of apertures can be used to create several deposits on a single filter, which can allow for application of different analytical techniques to different deposits.

The methods described above can also be used to “focus” several streams of aerosol into a single deposit. This method can be particularly beneficial for parallel particle impactor (PPI) style samplers (see e.g., U.S. Pat. No. 7,073,402). Due to its unique design of combining four impactors arranged in parallel, particles are deposited on a PPI filter mainly in four small distinct spots. Such deposition is not suitable for direct-on-filter analysis. Using the methods and apparatuses disclosed herein, however, particles or contaminants deposited on the PPI filter can be focused onto a small round area. Consequently, analysis of collected material can be performed directly on the filter.

An exemplary embodiment can relate to a sampler component. The sampler component can include a chamber configured to allow fluid to flow there-through. The sampler component can include a filter configured to remove particles or contaminants from the fluid as it passes through the chamber and capture the particles or contaminants on the filter. The sampler component can include a apertured-member including at least one aperture. The apertured-member can have zero-or low-fluid permeability to prevent the flow of fluid there-through. Fluid can freely pass through the at least one aperture and particles or contaminants are deposited on the filter in the area of the at least one aperture.

In some embodiments, the sampler component can be configured as a part for a fluid impactor device.

In some embodiments, the fluid is air.

In some embodiments, the chamber can include a fluid inlet and a fluid outlet.

Fluid can flow through the chamber in a direction from the fluid inlet to the fluid outlet. The filter can be located within the chamber. The apertured-member can be located within the chamber. The filter's location can be more proximate the fluid inlet than the apertured-member's location; and/or b) the apertured-member's location can be more proximate the fluid inlet than the filter's location.

In some embodiments, the filter can be adjacent the apertured-member.

In some embodiments, the filter can be in physical contact with the apertured-member.

In some embodiments, the filter can include a plurality of filters.

In some embodiments, the plurality of filters can include a first filter and a second filter. A configuration of the first filter can be different from a configuration of the second filter.

In some embodiments, the apertured-member can include a plurality of apertured-members.

In some embodiments, the plurality of apertured-members can include a first apertured-member and a second apertured-member. A configuration of the first apertured-member can be different from a configuration of the second apertured-member.

In some embodiments, the at least one aperture can be round, square, rectangular or triangular in shape.

In some embodiments, the at least one aperture can include a first aperture and a second aperture. A size of the first aperture can be different from a size of the second aperture. A shape of the first aperture can be different from a shape of the second aperture.

An exemplary embodiment can relate to a method of capturing particles or contaminants. The method can involve causing or allowing a fluid to flow through a sampler structure, wherein. The sampler structure can include a filter configured to remove particles or contaminants from the fluid as it flows through the sampler structure and capture said particles or contaminants on the filter. The sampler structure can include a apertured-member having at least one aperture. The apertured-member can have zero-or low-fluid permeability to prevent the flow of fluid there-through. Fluid can freely pass through the at least one aperture and particles or contaminants are deposited on the filter in the area of the at least one aperture. A region of the filter adjacent the at least one aperture can be a filter-aperture region. A region of the filter adjacent non-apertured portions of the apertured-member can be a filter-member region. Particles or contaminants can be captured on the filter in the filter-aperture region at a concentration that is greater than particles or contaminants captured on the filter in the filter-member region. In addition, or in the alternative, particles or contaminants can be captured on the filter in the filter-aperture region at a rate that is greater than particles or contaminants captured on the filter in the filter-member region.

In some embodiments, the sampler structure can include a fluid inlet and a fluid outlet. The filter's location can be more proximate the fluid inlet than the apertured-member's location. The method can involve causing or allowing fluid flowing through the sampler structure to force the filter in a direction towards the apertured-member.

In some embodiments, the sampler structure can include a chamber, a fluid inlet, and a fluid outlet. The method can involve causing or allowing fluid flowing through the sampler structure from the fluid inlet to the fluid outlet to make physical contact with the filter before making physical contact with the apertured-member, thereby reducing or eliminating particles or contaminants being deflected to a sidewall of the chamber.

Other details, objects, and advantages of the present invention will become apparent as the following description of certain exemplary embodiments thereof proceeds.

### BRIEF DESCRIPTION OF THE DRAWINGS

The above and other objects, aspects, features, advantages, and possible applications of embodiments of the present innovation will be more apparent from the following more particular description thereof, presented in conjunction with the following drawings. Like reference numbers used in the drawings may identify like components.

FIG. 1 is a schematic of an exemplary sampler component for an embodiment in which the filter is placed on a top of the apertured-member.

FIG. 2 is a schematic of an exemplary sampler component for an embodiment in which the filter is placed on a bottom of the apertured-member.

FIG. 3 is an exemplary filter showing particles or contaminants deposited in a filter when no apertured-membrane is used.

FIG. 4 shows a single apertured-member arrangement along with a particle or contaminant deposition formation on a filter when used in conjunction with the same, and a plural apertured-member arrangement along with a particle or contaminant deposition formation on a filter when used in conjunction with the same.

FIG. 5 is an exemplary sampler component.

### DETAILED DESCRIPTION OF THE INVENTION

The following description is of exemplary embodiments and methods of use that are presently contemplated for carrying out the present invention. This description is not to be taken in a limiting sense, but is made merely for the purpose of describing the general principles and features of various aspects of the present invention. The scope of the present invention is not limited by this description.

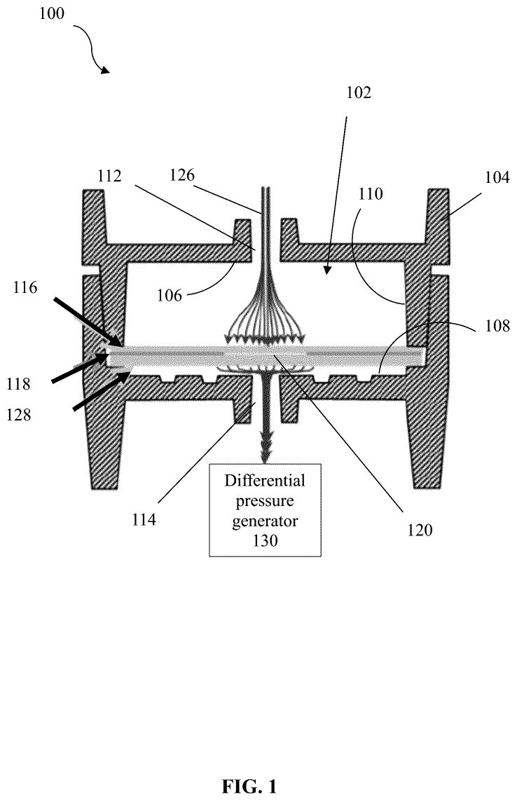

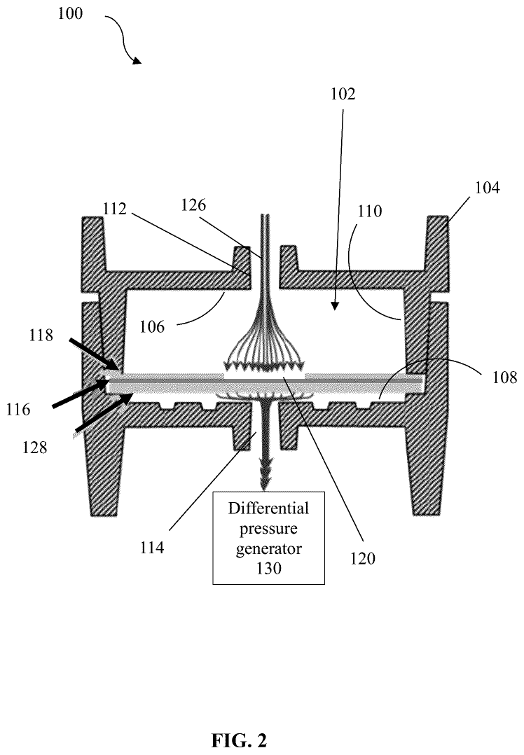

Referring to FIGS. 1-2, an exemplary embodiment can relate to a sampler component 100. The sampler component 100 can be a component of a sampler used to collect particles (e.g., particulate matter, contaminants, viruses, microbes, etc.). For example, the sampler can be a fluid impactor device—see e.g., U.S. Pat. No. 7,073,402 which is incorporated herein by reference in its entirety. The particles can be collected for later analysis. The sampler can be used to collect the particles that are being carried in a fluid (e.g., a liquid, a gas, or a mixture of both). In an exemplary embodiment, the fluid is air. The present disclosure may refer to the particles as contaminants, but it is understood that embodiments are not necessarily limited to collecting contaminants. For instance, the particles may be desired and the collection is done to sequester them for later use, determine a representative concentration of them being carried by the fluid, etc.

The sampler has a sampler component 100 through which particle-containing fluid is forced through or allowed to pass through. The means for forcing or allowing fluid to pass through can be a differential pressure generator 130 (e.g., gravity fed system, a pump, fan blower, etc.)—e.g., the differential pressure generator 130 can generate a fluid flow stream 126 of the particle-containing fluid. It is in this sampler component 100 that the particles are collected from the fluid.

The sampler component 100 can include a chamber 102 configured to allow fluid to flow there-through. For instance, the sampler component 100 can include a housing 104 having a top 106, a bottom 108, sidewalls 110, one or more fluid inlets 112 formed in the top 106, and one or more fluid outlets 114 formed in the bottom 108. The housing 104 can be made of rigid material, such as metal, metal alloy, plastic, ceramic, etc. The housing 104 can form a volume of space that is the chamber 102. The inner surfaces of the housing 104 can form a chamber top 106, chamber bottom 108, and chamber sidewalls 110. Fluid flows in the inlet(s) 112, through the chamber 102, and out the fluid outlet(s) 114 via a fluid flow stream 126. There can be an individual fluid flow stream 126 for each individual inlet 112. The number of fluid inlets 112 can be the same as or different from the number of fluid outlets 114. A shape and arrangement of an inlet(s) 112 can be the same as or different from a shape or arrangement of a fluid outlet(s) 114. Then placement or location of a fluid inlet(s) 112 in the housing top 106 can be such that it/they co-register (align or be co-axial) with or it/they do not co-register with the placement or location of a fluid outlet(s) 114.

The sampler component can include a filter 116 configured to remove particles or contaminants from the fluid as it passes through the chamber 102 and capture the particles or contaminants on the filter 116. The filter 116 can be a fiber material, woven material, non-woven material, etc. While it is contemplated for the sampler component 100 to have one filter 116, it is understood that more than one filter 116 can be used. For instance, the sampler component 100 can have multiple filters 116 in a stacked formation, multiple filters 116 in a laterally spaced formation, multiple filters 116 in baffle-like formation, multiple filters 116 in a herringbone formation, a filter 116 for each fluid flow stream 126, etc. The plurality of filters 116 can include a first filter 116, a second filter 116, etc. A configuration (e.g., type of material, shape, thickness, flow rate, flux, filter efficiency, sieve or mesh size, etc.) of the first filter 116 can be the same as or different from a configuration of the second filter 116.

It is contemplated for the filter(s) 116 to span a cross-section of the chamber 102 so as to prevent any fluid from flowing to the fluid outlet(s) 114 without having to flow first through the filter(s) 116. In an exemplary embodiment, the chamber 102 has a circular cross-section, and thus the filter 116 is a member having a circular profile, wherein the circular profile matches (or at least substantially matches) the circular cross-section of the chamber 102. Thus, the edges of the filter 116 are adjacent or abut against the chamber sidewalls 110. It is contemplated for the filter 116 to be a planar member. Thus, with the example of the filter 116 having a circular profile, the filter 116 can be a disc-shaped member.

The sampler component 100 can include an apertured-member 118—e.g., the apertured-member 118 can have one or more apertures 120. The apertured-member 118 can be configured to have zero-or low-fluid permeability to prevent the flow of fluid there-through, with the exception of through the aperture(s) 120. The apertured-member 118 can be made of metal, metal alloy, plastic, ceramic, etc. For instance, fluid can freely pass through the aperture(s) 120 of the apertured-member 118 so that particles can be deposited on the filter 116 in an area of the filter 116 corresponding to (e.g., aligned with) aperture(s) 120 (e.g., filter-aperture region 122).

While it is contemplated for the sampler component 100 to have one apertured-member 118, it is understood that more than one apertured-member 118 can be used. For instance, a plurality of apertured-members 118 can be used and include a first apertured-member 118, a second apertured-member 118, etc. A configuration (e.g., type of material, size, thickness, number, size, or shape (e.g., round, square, rectangular, triangular, etc.) of apertures, etc.) of the first apertured-member 118 can be the same as or different from different from a configuration of the second apertured-member 118.

Any apertured-member 118 can have any number of apertures 120. For instance, an apertured-member 118 can have a first aperture 120, a second aperture 120, etc. A size or shape of the first aperture 120 can be the same as or different from a size or shape of the second aperture 120.

It is contemplated for the apertured-member 118 to span a cross-section of the chamber 102 so as to prevent any fluid from flowing to the fluid outlet(s) without having to flow first through the aperture(s) 120 of the apertured-member 118. In an exemplary embodiment, the chamber 102 has a circular cross-section, and thus the apertured-member 118 is a member having a circular profile, wherein the circular profile matches (or at least substantially matches) the circular cross-section of the chamber 102. Thus, the edges of the apertured-member 118 are adjacent or abut against the chamber sidewalls 110. It is contemplated for the apertured-member 118 to be a planar member. Thus, with the example of the apertured-member 118 having a circular profile, the apertured-member 118 can be a disc-shaped member.

The housing 104 can include a support structure 128 configured to hold or retain the filter(s) 116 and/or apertured-member(s) 118 in place. The support structure 128 can be a shelf-like structure formed in the sidewall 110, a tab-like structure extending or protruding from the sidewall 110, a recess formed in the sidewall 110 or bottom 108, etc. upon or within which the filter(s) 116 and/or apertured member(s) 118 rest. In addition, or in the alternative, the support structure 128 can be a plate, grate, grid, etc. attached to the housing 104 or rested upon or within the formations discussed above, wherein the filter(s) 116 and/or apertured member(s) 118 rest upon that plate, grate, grid, etc.

In an exemplary embodiment, the chamber 102 can include a fluid inlet 112 and a fluid outlet 114. Fluid can flow through the chamber 102 in a direction from the fluid inlet 112 to the fluid outlet 114. The filter 116 can be located within the chamber 102. The apertured-member 118 can be located within the chamber 102. It is contemplated for the filter 116 to be adjacent the apertured-member 118. For instance, filter 116 can be in physical contact with the apertured-member 118. The filter's 116 location can be more proximate the fluid inlet 112 than the apertured-member's 118 location. Alternatively, or in addition (if more than one filter 116 and/or apertured-member 118 is used), the apertured-member's 118 location can be more proximate the fluid inlet 112 than the filter's 116 location.

An exemplary embodiment can relate to a method of capturing particles or contaminants. The method can involve causing or allowing a fluid to flow through a sampler structure (e.g., a sampler component 100). The sampler structure 100 can include a filter 116 configured to remove particles or contaminants from the fluid as the fluid flows through the sampler structure 100. This can cause or allow the sampler structure 100 to capture the particles or contaminants on the filter 116. The sampler structure 100 can include an apertured-member 118 having at least one aperture 120. The apertured-member 118 can have zero-or low-fluid permeability to prevent the flow of fluid there-through, except through the aperture(s) 120. A region(s) of the filter 116 adjacent the aperture(s) 120 can be referred to herein as a filter-aperture region(s) 122. A region(s) of the filter 116 adjacent non-apertured portions of the apertured-member 118 can be referred to herein as a filter-member region(s) 124. Fluid can freely pass through the aperture(s) 120 and particles or contaminants can be deposited on the filter 116 in an area of the filter 116 corresponding to (e.g., aligned with) aperture(s) 120 (e.g., filter-aperture region 122).

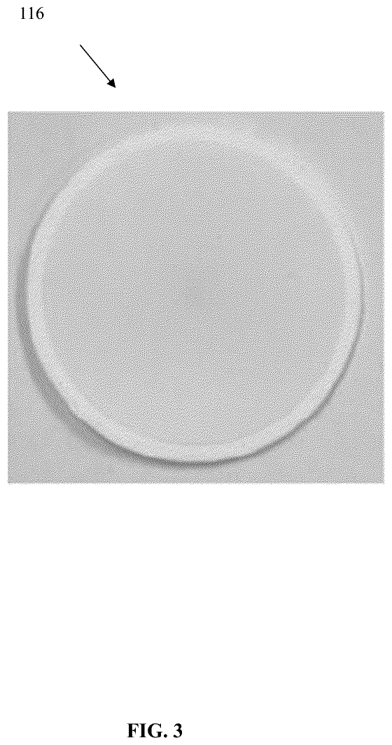

Referring to FIGS. 3-5, particles or contaminants can be captured on the filter 116 in the filter-aperture region(s) 122 at a concentration that is greater than particles or contaminants captured on the filter 116 in the filter-member region(s) 124. In addition, or in the alternative, particles or contaminants can be captured on the filter 116 in the filter-aperture region(s) 122 at a rate that is greater than particles or contaminants captured on the filter 116 in the filter-member region(s) 124. This effect can be explained via an example. Assume a configuration in which the sampler component 100 has one fluid inlet 112, one fluid outlet 114, one filter 116, and one apertured-member 118, wherein the apertured-member 118 has a single aperture 120 formed at a center location of the apertured-member 118. Further assume that the filter 116 is placed on top of the apertured-member 118 (e.g., the filter 116 is more proximate the fluid inlet 112 than the apertured-member 118 is). Thus, in operation, the fluid flow stream 126 enters the fluid inlet 112 and impinges the filter 116. The fluid flow stream 126 stays concentrated or collimated to the filter 116 at the filter filter-aperture region 122 because this is the path of least resistance. Thus, a fluid flow channel is formed through the filter 116 at the filter-aperture region 122. Filtration of the particles occurs mainly at the filter-aperture region 122.

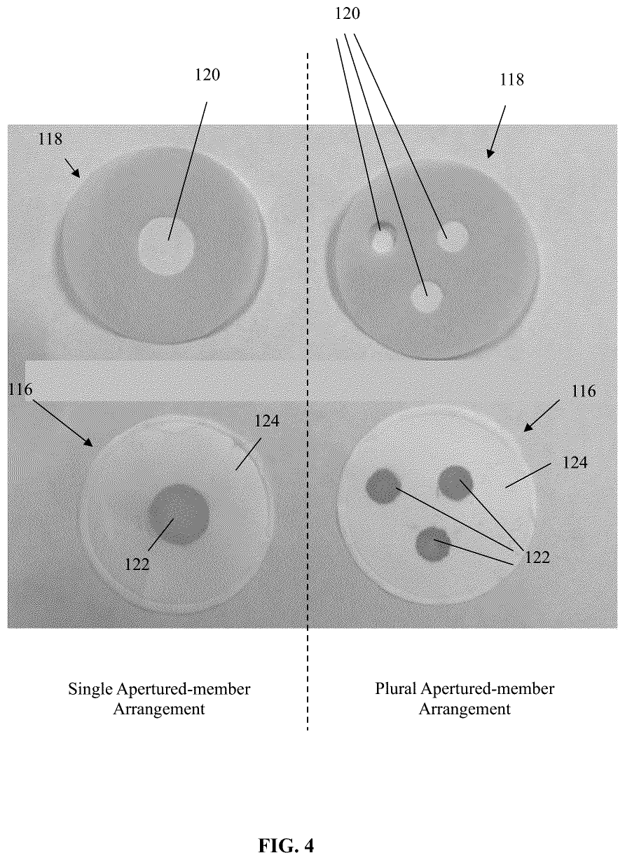

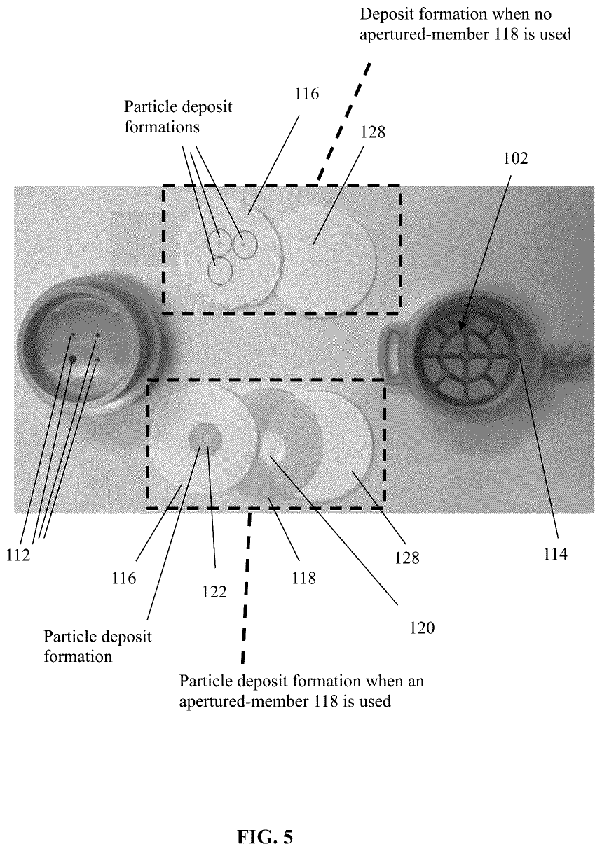

FIG. 3 shows is an exemplary filter 116 with particles deposited when no apertured-member 118 is used. The dispersed nature of the particle deposition can be seen, as compared to the more focused particle depositions shown in FIGS. 4 and 5. In FIG. 3, the outer rim or edge of the filter 116 was covered by the chamber sidewall 110, and thus no particles were deposited at the rim/edge. FIG. 4 shows a single apertured-member 118 arrangement along with a particle or contaminant deposition on a filter 116 when used in conjunction with the same, and a plural apertured-member 118 arrangement along with a particle or contaminant deposition on a filter 116 when used in conjunction with the same. The images clearly show a high concentration of captured particles due to the apertured-member 118. FIG. 5 shows particle deposit formation on the filter 116 when no apertured-member 118 is used, and particle deposit formation on the filter 116 when used in conjunction with an apertured-member 118. When no apertured-member 118 is used, particles deposit on the filter 116 in a dispersed manner and with little concentration at any area of the filter 116. When an apertured-member 118 is used, particles deposit on the filter 116 in a concentrated manner at the filter-aperture region 122.

With the filter 116 being placed on top of the apertured-member 118 (e.g., the filter 116 is more proximate the fluid inlet 112 than the apertured-member 118 is), the impinging fluid on the filter 116 can generate a force vector to force the filter 116 against the apertured-member 118 (e.g., force the filter 116 in a direction towards the apertured-member 118). This can be advantageous by reducing or eliminating any separation between the filter 116 and the apertured-member 118. Generally, the less space that exists between the filter 116 and the apertured-member 118, the better in regard to efficiency and efficacy of operation. For instance, a space formation can alter the formation of the fluid flow channel—e.g., cause a more dispersed fluid flow through the filter 116.

Not only does a well-defined fluid flow channel assist in improving efficiency in efficacy of particle capture, but it also forms a highly concentrated particle containment area of the filter 116—e.g., the particles are captured in a high-concentration at the filter-aperture region 122. This is beneficial from an analytical perspective because it is generally more desirous to have high concentrations for sample analysis. Without the apertured-member 118, the particles would be rather dispersed throughout the footprint of the filter 116.

The well-defined fluid flow channel also reduces or eliminates an adverse fluid flow (e.g., a whirl formation, a fluid redirection flow, etc.) of fluid within the chamber 102. This adverse fluid flow tends to cause particles to be deflected to and deposited on inner surfaces of the housing 104 forming the chamber 102 (e.g., they are deposited on the chamber top 106, chamber sidewalls 110, etc.).

As discussed above, there can be any number of fluid inlets 112, fluid outlets 114, and apertures 120 in the apertured-member 118. A user can design the sampler component 100 to generate distinct fluid flow streams 126 so as to cause distinct particle deposition formations on the filter 116. With several distinct and concentrated particle deposition formations, one can apply the same or different analytical technique to analyze each deposit formation.

It should be understood that modifications to the embodiments disclosed herein can be made to meet a particular set of design criteria. For instance, the number of or configuration of components or parameters may be used to meet a particular objective.

It will be apparent to those skilled in the art that numerous modifications and variations of the described examples and embodiments are possible in light of the above teachings of the disclosure. The disclosed examples and embodiments are presented for purposes of illustration only. Other alternative embodiments may include some or all of the features of the various embodiments disclosed herein. For instance, it is contemplated that a particular feature described, either individually or as part of an embodiment, can be combined with other individually described features, or parts of other embodiments. The elements and acts of the various embodiments described herein can therefore be combined to provide further embodiments.

It is the intent to cover all such modifications and alternative embodiments as may come within the true scope of this invention, which is to be given the full breadth thereof. Additionally, the disclosure of a range of values is a disclosure of every numerical value within that range, including the end points. Thus, while certain exemplary embodiments have been discussed and illustrated herein, it is to be distinctly understood that the invention is not limited thereto but may be otherwise variously embodied and practiced within the scope of the following claims.

What is claimed is:

1. A sampler component, comprising:
a chamber configured to allow fluid to flow there-through;
a filter configured to remove particles or contaminants from the fluid as it passes through the chamber and capture said particles or contaminants on the filter;
a apertured-member including at least one aperture, wherein:
the apertured-member has zero-or low-fluid permeability to prevent the flow of fluid there-through; and
fluid freely passes through the at least one aperture and particles or contaminants are deposited on the filter in the area of the at least one aperture.

2. The sampler component of claim 1, wherein:
the sampler component is configured as a part for a fluid impactor device.

3. The sampler component of claim 1, wherein:
the fluid is air.

4. The sampler component of claim 1, wherein:
the chamber includes a fluid inlet and a fluid outlet;
fluid flows through the chamber in a direction from the fluid inlet to the fluid outlet;
the filter is located within the chamber;
the apertured-member is located within the chamber; and
at least one of:
the filter's location is more proximate the fluid inlet than the apertured-member's location; or
the apertured-member's location is more proximate the fluid inlet than the filter's location.

5. The sampler component of claim 4, wherein:
the filter is adjacent the apertured-member.

6. The sampler component of claim 5, wherein:
the filter is in physical contact with the apertured-member.

7. The sampler component of claim 1, wherein:
the filter comprises a plurality of filters.

8. The sampler component of claim 7, wherein:
the plurality of filters includes a first filter and a second filter; and
a configuration of the first filter is different from a configuration of the second filter.

9. The sampler component of claim 1, wherein:
the apertured-member comprises a plurality of apertured-members.

10. The sampler component of claim 9, wherein:
the plurality of apertured-members includes a first apertured-member and a second apertured-member;
a configuration of the first apertured-member is different from a configuration of the second apertured-member.

11. The sampler component of claim 1, wherein the at least one aperture is round, square, rectangular or triangular in shape.

12. The sampler component of claim 1, wherein:
the at least one aperture includes a first aperture and a second aperture; and
a size of the first aperture is different from a size of the second aperture; and
a shape of the first aperture is different from a shape of the second aperture.

13. A method of capturing particles or contaminants, the method comprising:
causing or allowing a fluid to flow through a sampler structure, wherein:
the sampler structure includes a filter configured to remove particles or contaminants from the fluid as it flows through the sampler structure and capture said particles or contaminants on the filter;
the sampler structure includes a apertured-member having at least one aperture, wherein:
the apertured-member has zero-or low-fluid permeability to prevent the flow of fluid there-through; and
fluid freely passes through the at least one aperture and particles or contaminants are deposited on the filter in the area of the at least one aperture;
a region of the filter adjacent the at least one aperture is a filter-aperture region, and a region of the filter adjacent non-apertured portions of the apertured-member is a filter-member region;
wherein:
particles or contaminants are captured on the filter in the filter-aperture region at a concentration that is greater than particles or contaminants captured on the filter in the filter-member region; and/or
particles or contaminants are captured on the filter in the filter-aperture region at a rate that is greater than particles or contaminants captured on the filter in the filter-member region.

14. The method of claim 13, wherein the sampler structure includes a fluid inlet and a fluid outlet, and the filter's location is more proximate the fluid inlet than the apertured-member's location, the method further comprising:
causing or allowing fluid flowing through the sampler structure to force the filter in a direction towards the apertured-member.

15. The method of claim 13, wherein the sampler structure includes a chamber, a fluid inlet, and a fluid outlet, the method further comprising:
causing or allowing fluid flowing through the sampler structure from the fluid inlet to the fluid outlet to make physical contact with the filter before making physical contact with the apertured-member, thereby reducing or eliminating particles or contaminants being deflected to a sidewall of the chamber.
